(19) United States
(12) Patent Application Publication
(10) Pub. No.: US 2013/0190945 A1
(43) Pub. Date: Jul. 25, 2013

(54) VEHICLE MASS ESTIMATING APPARATUS

(71) Applicant: ADVICS CO., LTD., Kariya-shi (JP)

(72) Inventors: Hideaki KOTO, Anjo-shi (JP); Chihiro NITTA, Aichi-ken (JP)

(73) Assignee: ADVICS CO., LTD., Kariya-shi (JP)

(21) Appl. No.: 13/749,810

(22) Filed: Jan. 25, 2013

(30) Foreign Application Priority Data
Jan. 25, 2012 (JP) 2012-013542

(51) Int. Cl. G06F 17/00

(52) U.S. Cl. CPC G06F 17/00
USPC 701/1

(57) ABSTRACT

There is provided a vehicle mass estimating apparatus including an acceleration detecting unit which detects an acceleration of a vehicle, a driving-force calculating unit which calculates a driving force of the vehicle corresponding to the acceleration, a steering-angle associated value detecting unit which detects a steering-angle associated value which is associated with a steering angle of the vehicle at a detection time of the acceleration, and a mass estimating unit which estimates a vehicle mass at the detection time of the acceleration based on the acceleration and the driving force on a condition that the steering angle associated value satisfies a predetermined condition.

### CROSS REFERENCE TO RELATED APPLICATIONS

This application is based on and claims priority under 35 U.S.C. §119 to Japanese Patent Application 2012-013542, filed on Jan. 25, 2012, the entire content of which is incorporated herein by reference.

### BACKGROUND

1. Field of the Invention

The present invention relates to a vehicle mass estimating apparatus for estimating a vehicle mass.

2. Description of Related Art

There has been known a vehicle mass estimating apparatus for estimating a vehicle mass (for example, JP-A-2000-74727). The vehicle mass estimating apparatus disclosed in JP-A-2000-74727 detects an acceleration when a vehicle is running by different driving forces, and derives two motion equations. Then, the vehicle mass estimating apparatus calculates the difference between the two motion equations by subtraction, thereby cancelling running resistance occurring at the vehicle and estimating the vehicle mass. In this way, the vehicle mass estimating apparatus reduces an estimation error of the vehicle mass due to the running resistance.

However, the above-described vehicle mass estimating apparatus makes estimation on the assumption that the running resistance is constant between two acceleration detecting timings. Therefore, if the running resistance varies between two acceleration detecting timings, it is difficult to accurately estimate the vehicle mass.

### SUMMARY

The present invention has been made in view of the above circumferences, and an object of the present invention is to provide a vehicle mass estimating apparatus capable of improving the accuracy of estimation of vehicle mass.

According to an illustrative embodiment of the present invention, there is provided a vehicle mass estimating apparatus including an acceleration detecting unit which detects an acceleration of a vehicle, a driving-force calculating unit which calculates a driving force of the vehicle corresponding to the acceleration, a steering-angle associated value detecting unit which detects a steering-angle associated value which is associated with a steering angle of the vehicle at a detection time of the acceleration, and a mass estimating unit which estimates a vehicle mass at the detection time of the acceleration based on the acceleration and the driving force on a condition that the steering angle associated value satisfies a predetermined condition.

According to the vehicle mass estimating apparatus, on a condition that the steering-angle associated value when the acceleration is detected (for example, at the same time as the detection of the acceleration) satisfies the predetermined condition, the mass estimating unit makes estimation of the vehicle mass. Therefore, it is possible to suppress an error of vehicle mass estimation based on a cornering drag included in the running resistance occurring at the vehicle, thereby improving the accuracy of the estimation of the vehicle mass.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a configuration diagram illustrating an exemplary configuration of a vehicle mass estimating apparatus;

FIG. 2 is a block diagram illustrating an exemplary control block of a calculating unit 3;

FIG. 3 is a flow chart illustrating an exemplary procedure of estimating vehicle mass M according to a first illustrative embodiment;

FIG. 4 is an explanatory view illustrating an exemplary relation among a throttle opening degree φ, an engine speed ω, and an output torque τ;

FIG. 5A to 5C are explanatory views illustrating an exemplary relation among a steering angle θ, an acceleration α, and a cornering drag Fc, wherein FIG. 5A illustrates a change in the steering angle θ with time, FIG. 5B illustrates a change in the acceleration α with time, and FIG. 5C illustrates a change in the cornering drag Fc with time;

FIG. 6 is a flow chart illustrating an exemplary procedure of determining whether the vehicle mass M can be estimated according to the first illustrative embodiment;

FIG. 7 is a flow chart illustrating an exemplary procedure of estimating the vehicle mass M according to a second illustrative embodiment; and

FIG. 8 is a flow chart illustrating an exemplary procedure of determining whether the vehicle mass M can be estimated according to the second illustrative embodiment.

### DETAILED DESCRIPTION

Hereinafter, illustrative embodiments of the present invention will be described with reference to the accompanying drawings. Parts common among the respective illustrative embodiments are denoted by the same reference symbols, and repeated description will not be made. Also, the drawings are conceptual views, and do not define the dimensions of detailed structures.

### (1) First Illustrative Embodiment

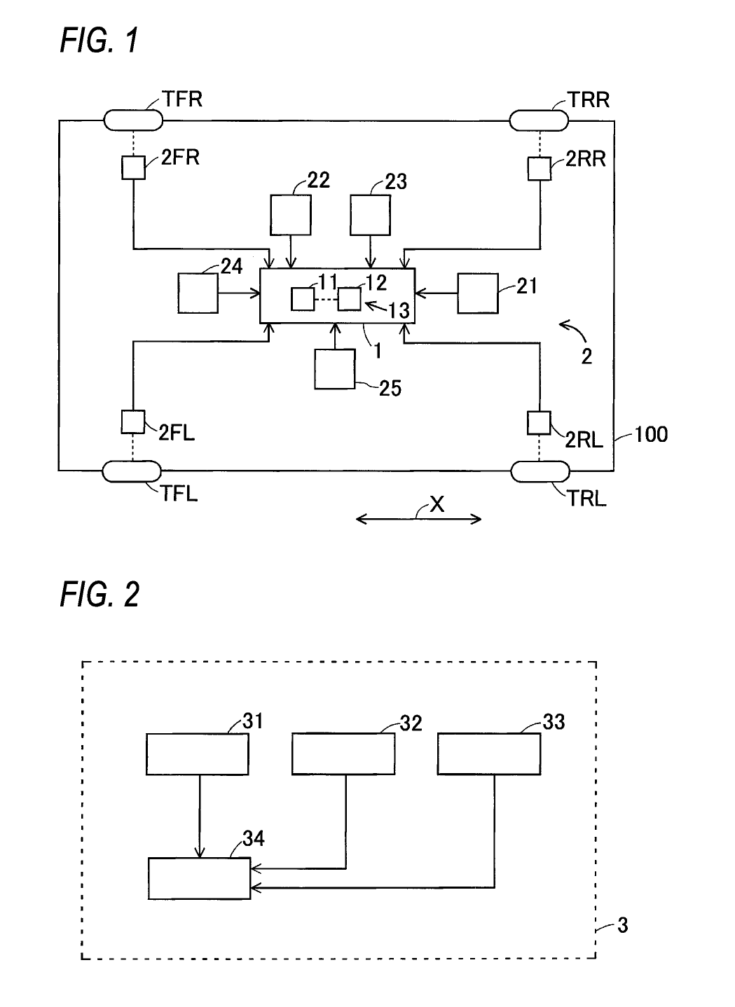

FIG. 1 is a configuration diagram illustrating an exemplary configuration of a vehicle mass estimating apparatus. The vehicle mass estimating apparatus of the present illustrative embodiment includes a calculating device 1 which estimates vehicle mass M, and a detecting unit 2 which detects the running condition of a vehicle 100 and an operating amount made by a driver.

The calculating device 1 includes a micro-computer 13 having a CPU 11 and a memory 12, and executes a program stored in the memory 12, thereby capable of estimating the vehicle mass M. The vehicle mass M includes the mass of the main body of the vehicle, the mass of crew members getting in the vehicle 100, the mass of loads loaded in the vehicle 100, and so on. The calculating device 1 is electrically connected to the detecting unit 2, and can acquire vehicle information from the detecting unit 2. The vehicle information includes the running condition of the vehicle 100 and the operating amount made by the driver. The vehicle information transmitted from the detecting unit 2 is stored in the memory 12.

The detecting unit 2 includes an acceleration sensor 21, an engine rotation sensor 22, an accelerator stroke sensor 23, a steering angle sensor 24, a vehicle speed sensor 25, and wheel speed sensors 2FR, 2FL, 2RR, and 2RL. A known detector for a vehicle can be used for each of those sensors. The acceleration sensor 21 detects the acceleration α of the vehicle 100 in forward/backward movement directions (directions shown by an arrow X). The engine rotation sensor 22 detects the engine speed co of an engine (not shown), and the accelerator stroke sensor 23 detects the step-on amount (stroke amount) of an accelerator pedal (not shown) by the driver. The steering angle sensor 24 detects the operating amount (steering angle) of a steering wheel (not shown) by the driver.

The vehicle speed sensor 25 detects the rotation speed of an output shaft of a transmission (not shown). The wheel speed sensors 2FR, 2FL, 2RR, and 2RL detect the rotation speeds of wheels TFR, TFL, TRR, and TRL, respectively. In the present application, the rotation speed which is detected by the vehicle speed sensor 25 will be described as the vehicle speed V of the vehicle 100. However, the vehicle speed V of the vehicle 100 can also be calculated from the rotation speeds which are detected by the wheel speed sensors 2FR, 2FL, 2RR, and 2RL. Also, the vehicle 100 can be driven even by any one of front-wheel drive, rear-wheel drive, and four-wheel drive.

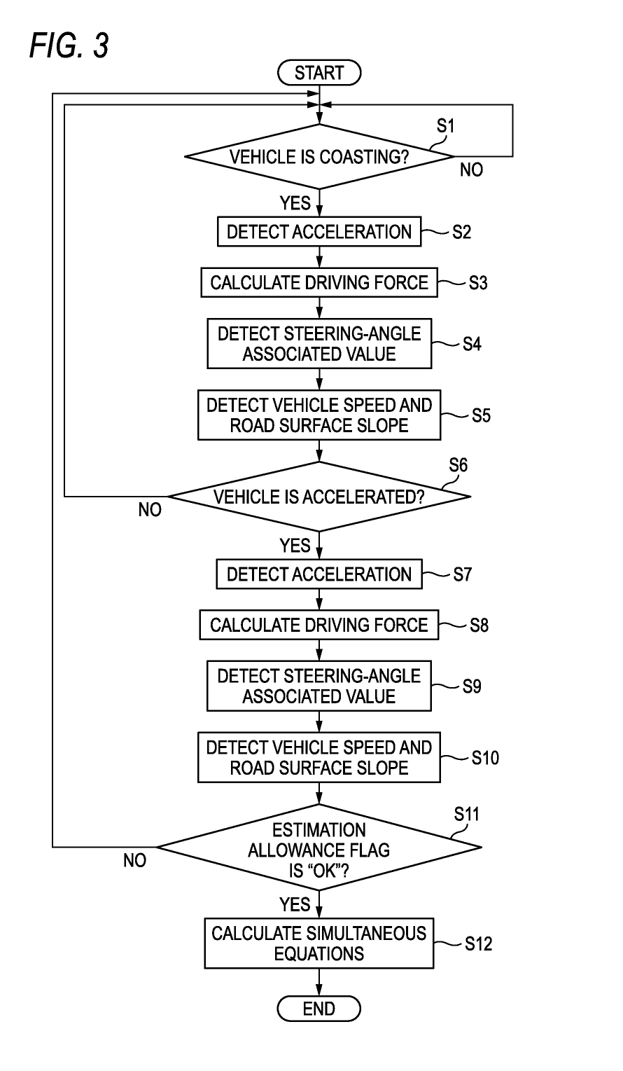

FIG. 2 is a block diagram illustrating an exemplary control block of a calculating unit 3. FIG. 3 is a flow chart illustrating an exemplary procedure of estimating the vehicle mass M. If considering the calculating device 1 in a view point of a control block, the calculating device 1 includes the calculating unit 3, and the calculating unit 3 includes an acceleration detecting unit 31 which detects the acceleration α of the vehicle 100, a driving-force calculating unit 32 which calculates the driving force Fp of the vehicle 100 corresponding to the acceleration α, a steering-angle associated value detecting unit 33 which detects a steering-angle associated value STR, and a mass estimating unit 34 which estimates the vehicle mass M based on the acceleration α, the driving force Fp, and the steering-angle associated value STR.

The calculating unit 3 executes a program following the flow chart of FIG. 3, thereby capable of estimating the vehicle mass M. That is, in Step S1, the calculating unit 3 determines whether the vehicle 100 is coasting. When the vehicle 100 is coasting, the calculating unit 3 detects the acceleration α for the first time in Step S2, and calculates the driving force Fp for the first time in Step S3. Then, the calculating unit 3 detects the steering-angle associated value STR for the first time in Step S4, and detects the vehicle speed V and a road surface slope δ for the first time in Step S5. The acceleration α, the driving force Fp, the steering-angle associated value STR, the vehicle speed V, and the road surface slope δ detected or calculated in Steps S2 to S5 are set as an acceleration α1, a driving force Fp1, a steering-angle associated value STR1, a vehicle speed V1, and a road surface slope δ1.

Next, in Step S6, the calculating unit 3 determines whether the vehicle 100 is accelerated within a predetermined time. When the vehicle 100 is accelerated within the predetermined time, the calculating unit 3 detects the acceleration α for the second time in Step S7, and calculates the driving force Fp for the second time in Step S8. Then, the calculating unit 3 detects the steering-angle associated value STR for the second time in Step S9, and detects the vehicle speed V and the road surface slope δ for the second time in Step S10. The acceleration α, the driving force Fp, the steering-angle associated value STR, the vehicle speed V, and the road surface slope δ detected or calculated in Steps S7 to S10 are set as an acceleration α2, a driving force Fp2, a steering-angle associated value STR2, a vehicle speed V2, and a road surface slope δ2.

Next, in Step S11, the calculating unit 3 determines whether the vehicle mass M can be estimated. If an estimation allowance flag (described below) is “OK (allow)”, the procedure proceeds to Step S12 where the calculating unit 3 calculates simultaneous equations, thereby estimating the vehicle mass M. If the estimation allowance flag is “NG (disallow)”, or if it is determined in Step S6 that the vehicle 100 is not accelerated within the predetermined time, the calculating unit 3 returns to Step S1. Meanwhile, when the vehicle 100 is not coasting in Step S1, the calculating unit 3 waits for the vehicle 100 to coast.

The determination on whether the vehicle is coasting, the determination on whether the vehicle is accelerated, and the detection of the acceleration α are performed by the acceleration detecting unit 31. The calculation of the driving force Fp is performed by the driving-force calculating unit 32, and the detection of the steering-angle associated value STR is performed by the steering-angle associated value detecting unit 33. The detection of the vehicle speed V and the road surface slope δ, the determination on whether the vehicle mass M can be estimated, and the calculation of the simultaneous equations are performed by the mass estimating unit 34. Hereinafter, the calculating unit 3 will be described in more detail.

(Acceleration Detecting Unit 31)

The acceleration detecting unit 31 detects the acceleration α1 of the vehicle 100 during coasting and the acceleration α2 of the vehicle 100 during acceleration. As the accelerations α1 and α2 of the vehicle 100, detection values of the acceleration sensor 21 can be used. Also, the accelerations α1 and α2 of the vehicle 100 can be calculated by differentiating the detection values of the vehicle speed sensor 25 (vehicle speeds V), or can be used together to reduce a detection error.

Whether the vehicle 100 is coasting can be determined, for example, according to whether the ratio between the engine speed ω and a speed obtained from the vehicle speed V is within a predetermined range. If the ratio between the engine speed ω and the speed obtained from the vehicle speed V is not within the predetermined range, the acceleration detecting unit 31 determines that the driving force from the engine is not being transmitted to a drive wheel (a clutch is disengaged), and determines that the vehicle 100 is coasting. Meanwhile, if the ratio between the engine speed ω and the speed obtained from the vehicle speed V is within the predetermined range, the acceleration detecting unit 31 determines that the driving force from the engine is being transmitted to the drive wheel (the clutch is engaged), and determines that the vehicle 100 is not coasting. In this case, the vehicle 100 is accelerated or decelerated.

Whether the vehicle 100 is being accelerated can be determined based on whether the acceleration α increases in a predetermined time in a state where the ratio between the engine speed ω and the speed obtained from the vehicle speed V is within a predetermined range, that is, in a state where the driving force from the engine is being transmitted to the drive wheel (the clutch is engaged). If the acceleration α increases, the acceleration detecting unit 31 determines that the vehicle 100 is being accelerated. If the acceleration α is constant or decreases, the acceleration detecting unit 31 determines that the vehicle 100 is not being accelerated. As the engine speed ω, the detection value of the engine rotation sensor 22 can be used, and as the vehicle speed V, the detection value of the vehicle speed sensor 25 can be used. The speed obtained from the vehicle speed V can be calculated from the number of pulses of the detection value of the vehicle speed sensor 25. Also, the determination on whether the vehicle 100 is coasting, and the determination on whether the vehicle is being accelerated can be performed using a detection signal representing the gear position of the transmission.

For example, when the transmission is shifted from the first gear to the second gear, the acceleration detecting unit 31 can detect the acceleration α1 of the vehicle 100 during coasting and the acceleration α2 of the vehicle 100 during acceleration. In addition, for example, at timings when the transmission is shifted from the second gear to the third gear, from the third gear to the fourth gear, or the like, it is possible to detect the acceleration α1 and α2 of the vehicle 100. Also, the acceleration detecting unit 31 can detect the accelerations α1 and α2 of the vehicle 100 at the plurality of timings, and can use them together to reduce an error of the detection and an estimation error of the vehicle mass M.

In the present illustrative embodiment, since the acceleration α1 of the vehicle 100 during coasting and the acceleration α2 of the vehicle 100 during acceleration are used, it is possible to use a larger acceleration difference (α2−α1) between accelerations α1 and α2 as compared to a case of detecting acceleration for the two times both during acceleration. Therefore, when using motion equations (described below) to estimate the vehicle mass M, it is possible to reduce an estimation error of the vehicle mass M. This is true even as compared to a case of detecting the acceleration for the two times both during deceleration.

(Driving-Force Calculating Unit 32)

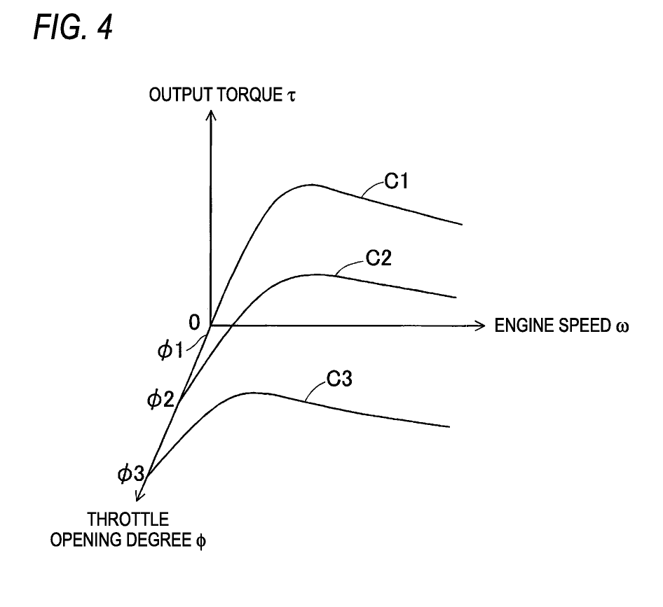

The driving-force calculating unit 32 calculates the driving forces Fp1 and Fp2 of the vehicle 100 corresponding to the accelerations α1 and α2. FIG. 4 is an explanatory view illustrating an exemplary relation among a throttle opening degree φ, an engine speed ω, and an output torque τ. In FIG. 4, the throttle opening degree φ, the engine speed ω, and the output torque τ are represented at orthogonal coordinate axes, respectively, such that the relation among them is three-dimensionally shown. The vehicle 100 has a throttle (not shown), and the throttle is adjusted by controlling the opening of a valve, whereby an inflow of mixture gas into the engine can be controlled such that the engine output (the output torque τ) is adjusted. The throttle opening degree φ corresponds to the detection value of the accelerator stroke sensor 23. Also, for example, in a vehicle which does not have a throttle such as a diesel engine, the throttle opening degree φ can be replaced with an amount of fuel consumption.

A curved line C1 represents the relation between the engine speed co and the output torque τ when the throttle opening degree φ is φ1. Similarly, a curved line C2 represents the relation between the engine speed ω and the output torque τ when the throttle opening degree φ is φ2, and a curved line C3 represents the relation between the engine speed ω and the output torque τ when the throttle opening degree φ is φ3. The curved lines C1 to C3 have characteristics obtained in advance by simulations, measurement using actual equipment, or the like, and can be stored by a map, a table, a relational expression, or the like, in the memory 12.

When the acceleration detecting unit 31 detects the acceleration α1, the driving-force calculating unit 32 acquires the throttle opening degree φ from the detection value of the accelerator stroke sensor 23, and acquires the engine speed ω from the detection value of the engine rotation sensor 22. The driving-force calculating unit 32 reads the output torque τ corresponding to the throttle opening degree φ and the engine speed ω from the memory 12, and subtracts a loss due to the inertia of the drive system of the vehicle from the read output torque τ. Then, the driving-force calculating unit 32 multiplies the output torque obtained by subtracting the loss due to the inertia from the read output torque τ, by the transmission gear ratio of the transmission, and subtracts a drive loss from the value obtained by the multiplication, thereby capable of calculating the driving force Fp1 of the vehicle 100. Similarly, the driving-force calculating unit 32 can calculate the driving force Fp2 of the vehicle 100 corresponding to the acceleration α2.

The loss due to the inertia and the drive loss can be stored in advance by a map, a table, a relational expression, or the like, in the memory 12. The drive loss is a loss of the drive system of the vehicle obtained by subtracting the output at the drive wheel from the engine output, and does not include a disturbance factor such as running resistance. The transmission gear ratio of the transmission can be calculated from the above-mentioned ratio between the engine speed ω and the speed obtained from the vehicle speed V, and can also be calculated using the detection signal representing the gear position of the transmission. Also, if using the rotation speeds which are detected by the wheel speed sensors 2FR, 2FL, 2RR, and 2RL, the output torque obtained by subtracting the loss due to the inertia from the read output torque is multiplied by the transmission gear ratio of the transmission and the speed reduction ratio of a differential (not shown), and the drive loss is subtracted from the value obtained by the multiplication, whereby it is possible to calculate the driving forces Fp1 and Fp2 of the vehicle 100.

(Steering-Angle Associated Value Detecting Unit 33)

The steering-angle associated value detecting unit 33 detects the steering-angle associated values STR1 and STR2 associated with the steering angles θ1 and θ2 of the vehicle 100 at the detection times of the accelerations α1 and α2. As the steering-angle associated values STR1 and STR2, the steering angles θ1 and θ2 and/or steering speeds Vθ1 and Vθ2 can be used. In the present illustrative embodiment, as the steering-angle associated values STR1 and STR2, the steering angles θ1 and θ2 and the steering speeds Vθ1 and Vθ2 are detected. As the steering angles θ1 and θ2, detection values of the steering angle sensor 24 can be used, and the steering speeds Vθ1 and Vθ2 can be calculated by differentiating the steering angles θ1 and θ2 with respect to time, respectively.

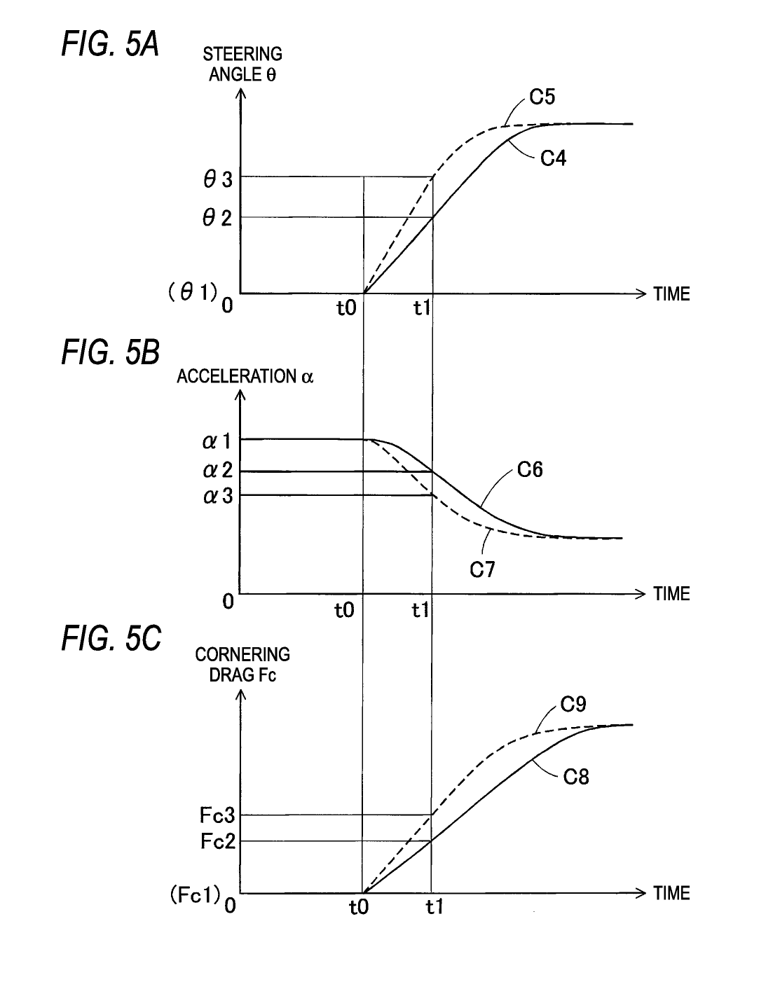

FIG. 5A to 5C are explanatory views illustrating an exemplary relation among a steering angle θ, an acceleration α, and a cornering drag Fc. Specifically, FIG. 5A illustrates a change in the steering angle θ with time, FIG. 5B illustrates a change in the acceleration α with time, and FIG. 5C illustrates a change in the cornering drag Fc with time. A curved line C4 shown by a solid line represents a change in the steering angle θ with time in a case of the steering speed Vθ1, and a curved line C5 shown by a broken line represents a change in the steering angle θ with time in a case of the steering speed Vθ2. Also, a curved line C6 shown by a solid line represents a change in the acceleration α with time in the case of the steering speed Vθ1, and a curved line C7 shown by a broken line represents a change in the acceleration α with time in the case of the steering speed Vθ2. A curved line C8 shown by a solid line represents a change in the cornering drag Fc with time in the case of the steering speed Vθ1, and a curved line C9 shown by a broken line represents a change in the cornering drag Fc with time in the case of the steering speed Vθ2. Also, in FIGS. 5A to 5C, it is assumed that the steering speed Vθ2 is larger than the steering speed Vθ1. Further, the cornering drag Fc is a frictional force between tires and a road surface generated in the backward movement direction of the vehicle 100, and is included in the running resistance Fr of the vehicle 100 (described below). The relation between the steering angle θ and the cornering drag Fc has characteristics obtained in advance by simulations, measurement using actual equipment, or the like, and can be stored by a map, a table, a relational expression, or the like in the memory 12.

It is assumed that the driver starts rotation of the steering wheel at a time t0. The steering angle θ, the acceleration α, and the cornering drag Fc at that time are set as the steering angle θ1 (which is 0 in FIG. 5A), the acceleration α1, and the cornering drag Fc1 (which is 0 in FIG. 5C). At a time t1, the steering angle θ is a steering angle θ2 in the case of the steering speed Vθ1 (the curved line C4), and is a steering angle θ3 in the case of the steering speed Vθ2 (the curved line C5). At the time t1, the acceleration α is the acceleration α2 in the case of the steering speed Vθ1 (the curved line C6), and is the acceleration α3 in the case of the steering speed Vθ2 (the curved line C7). At the time t1, the cornering drag Fc is a cornering drag Fc2 in the case of the steering speed Vθ1 (the curved line C8), and is a cornering drag Fc3 in the case of the steering speed Vθ2 (the curved line C9).

If the steering angle θ increases, the cornering drag Fc increases, and the acceleration α decreases. Since the steering speed Vθ2 is larger than the steering speed Vθ1, the cornering drag Fc3 is larger than the cornering drag Fc2, and the acceleration α3 is smaller than the acceleration α2. That is, an increase in the cornering drag Fc and a decrease in the acceleration α after rotation of the steering wheel depend on a steering speed Vθ.

In the present illustrative embodiment, since the steering-angle associated value detecting unit 33 detects the steering angles θ1 and θ2 as the steering-angle associated values STR1 and STR2, it is possible to use the relation between the steering angles θ1 and θ2 and the cornering drag Fc to determine the magnitude of the cornering drag Fc. Therefore, it is easy to determine whether the vehicle mass M can be estimated (described below). Also, since the steering-angle associated value detecting unit 33 detects the steering speeds Vθ1 and Vθ2 of the vehicle 100 as the steering-angle associated values STR1 and STR2, it is possible to predict an increase or decrease in the cornering drag Fc. Therefore, it is possible to suppress an estimation error of the vehicle mass M from increasing according to an increase in the cornering drag Fc.

(Mass Estimating Unit 34)

The mass estimating unit 34 detects the vehicle speeds V1 and V2 of the vehicle 100 and road surface slopes δ1 and δ2 at the detection times of the accelerations α1 and α2. As the vehicle speeds V1 and V2, detection values of the vehicle speed sensor 25 can be used. The road surface slope δ1 or δ2 can be derived, for example, from the difference between a detection value of the acceleration sensor 21 and an estimated acceleration calculated from detection values of the wheel speed sensors 2FR, 2FL, 2RR, and 2RL. The estimated acceleration can be calculated by differentiating the detection values of the wheel speed sensors 2FR, 2FL, 2RR, and 2RL with respect to time. Also, in order to calculate the road surface slopes δ1 or δ, only the detection value of the acceleration sensor 21 can be used.

The mass estimating unit 34 uses relational expressions (motion equations) represented by the following equations 1 and 2, to estimate the vehicle mass M. In this case, the running resistances Fr occurring at the vehicle 100 at the detection times of the accelerations α1 and α2 are represented by Fr1 and Fr2, respectively.

M×α1=Fp1−Fr1 (Equation 1)

M×α2=Fp2−Fr2 (Equation 2)

First, it is assumed a case where the running resistances Fr1 and Fr2 at the two detection times of the accelerations α1 and α2 are equal to each other. In this case, the mass estimating unit 34 calculates the simultaneous equations represented by equations 1 and 2, thereby capable of calculating the vehicle mass M. In other words, the vehicle mass M can be represented by the following equation 3.

M=(Fp1−Fp2)/(α1−α2) (Equation 3)

Next, it is assumed a case where the running resistances Fr1 and Fr2 at the two detection times of the accelerations α1 and α2 are different from each other. The running resistance Fr includes rolling resistance Ft, wind resistance Fw, resistance Fx occurring in the backward movement direction of the vehicle, and the cornering drag Fc. The rolling resistance Ft is proportional to the vehicle mass M, and the wind resistance Fw is proportional to the square of the vehicle speed V. The resistance Fx can be represented by (Mg×sin δ) using acceleration g of gravity and a road surface slope δ. The cornering drag Fc is proportional to the steering angle θ. Therefore, if the vehicle speed V, the road surface slope δ, or the steering angle θ increases, the running resistance Fr increases, and thus it becomes not possible to ignore the difference (Fr1−Fr2) between the running resistances Fr1 and Fr2.

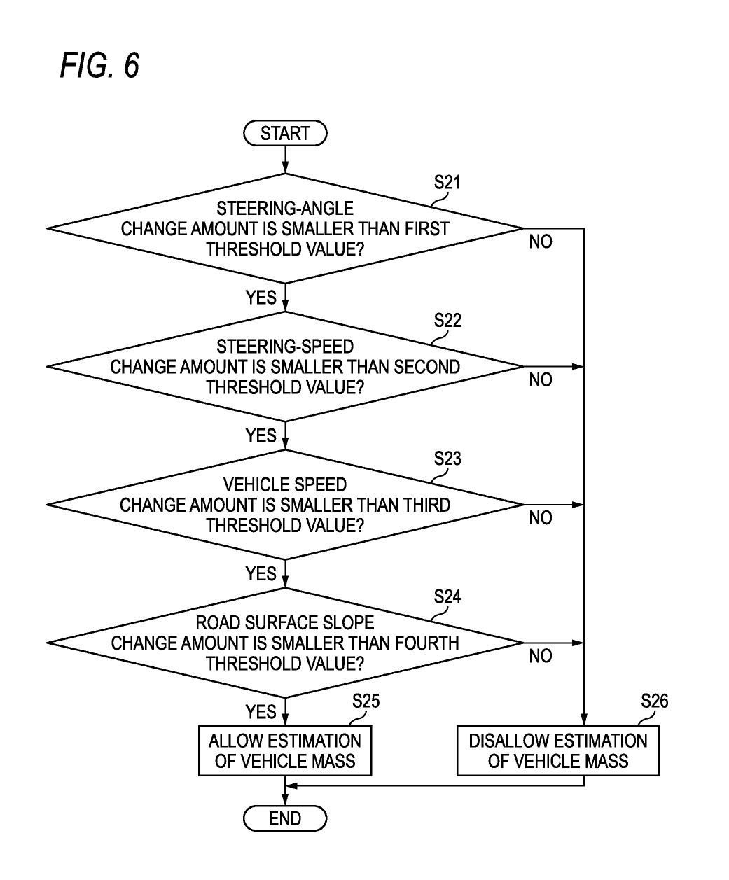

Therefore, the mass estimating unit 34 estimates the vehicle mass M when a difference (Fr1−Fr2) between the running resistances Fr1 and Fr2 at the detection times of the accelerations α1 and α2 is small. Particularly, in the present illustrative embodiment, the mass estimating unit 34 estimates the vehicle mass M on a condition that a change amount (STR2−STR1) between the steering-angle associated values STR1 and STR2 is smaller than a predetermined threshold value. FIG. 6 is a flow chart illustrating an exemplary procedure of determining whether the vehicle mass M can be estimated. In FIG. 6, as the steering-angle associated values STR1 and STR2, the steering angles θ1 and θ2 and the steering speeds Vθ1 and Vθ2 are used. In Step S21, the mass estimating unit 34 determines whether a steering-angle change amount (θ2−θ1) which is a change amount between the steering angles θ1 and θ2 at the detection times of the accelerations α1 and α2 is smaller than a first threshold value TH1. When the steering-angle change amount (θ2−θ1) is smaller than the first threshold value TH1, the procedure proceeds to Step S22. In Step S22, the mass estimating unit 34 determines whether a steering-speed change amount (Vθ2−Vθ1) at the detection times of the accelerations α1 and α2 is smaller than a second threshold value TH2. When the steering-speed change amount (Vθ2−Vθ1) is smaller than the second threshold value TH2, the procedure proceeds to Step S23.

In Step S23, the mass estimating unit 34 determines whether a vehicle speed change amount (V2−V1) which is a change amount between the vehicle speeds V1 and V2 at the detection times of the accelerations α1 and α2 is smaller than a third threshold value TH3. When the vehicle speed change amount (V2−V1) is smaller than the third threshold value TH3, the procedure proceeds to Step S24. In Step S24, the mass estimating unit 34 determines whether a road surface slope change amount (δ2−δ1) which is a change amount between the road surface slopes δ1 and δ2 at the detection times of the accelerations α1 and α2 is smaller than a fourth threshold value TH4. When the road surface slope change amount (δ2−δ1) is smaller than the fourth threshold value TH4, the procedure proceeds to Step S25 where the mass estimating unit 34 sets the estimation allowance flag of the vehicle mass M to “OK (allow)”. Then, the mass estimating unit 34 calculates the simultaneous equations represented by the above-mentioned equations 1 and 2, thereby estimating the vehicle mass M. When at least one of the conditions of Steps S21 to S24 is not satisfied, the procedure proceeds to Step S26 where the mass estimating unit 34 sets the estimation allowance flag of the vehicle mass M to “NG (disallow)”. In this case, the mass estimating unit 34 does not estimate the vehicle mass M. Here, the first to fourth threshold values TH1 to TH4 are acceptable values at which it is possible to ignore the running resistance Fr, and can be derived in advance by simulations, measurement using actual equipment, or the like, and be stored in the memory 12.

In the present illustrative embodiment, since the mass estimating unit 34 estimates the vehicle mass M when the change amount between the steering-angle associated values STR1 and STR2 at the detection times of the accelerations α1 and α2 is smaller than the predetermined threshold value, it is possible to suppress an estimation error of the vehicle mass M based on the cornering drag Fc included in the running resistance Fr occurring at the vehicle 100, thereby improving the accuracy of estimation of the vehicle mass M. Also, in the present illustrative embodiment, two relational expressions (equations 1 and 2) representing the relations among the accelerations α1 and α2, the driving forces Fp1 and Fp2, the running resistances Fr1 and Fr2 of the vehicle 100, and the vehicle mass M are used to estimate the vehicle mass M. According to this configuration, if the running resistance Fr of the vehicle 100 is constant, it is possible to cancel the running resistance Fr occurring at the vehicle 100 and estimate the vehicle mass M.

However, the cornering drag Fc which is a factor of the running resistance Fr of the vehicle 100 varies more easily than the other factors of the running resistance Fr do. In the present illustrative embodiment, since the vehicle mass M is estimated when the change amount between the steering-angle associated values STR1 and STR2 at the detection times of the accelerations α1 and α2 is smaller than the predetermined threshold value, it is possible to suppress an estimation error attributable to the running resistance Fr of the vehicle 100, thereby improving the accuracy of estimation of the vehicle mass M.

### (2) Second Illustrative Embodiment

The second illustrative embodiment uses one relational expression (motion equation) to estimate the vehicle mass M, and is different from the first illustrative embodiment in that point. The calculating unit 3 can estimate the vehicle mass M in one of running conditions where the vehicle 100 is being accelerated, decelerated, or coasting. In the second illustrative embodiment, it is described the case where the vehicle mass M is estimated when the vehicle 100 is being accelerated. However, even when the vehicle 100 is being decelerated or coasting, it is possible to estimate the vehicle mass M similarly.

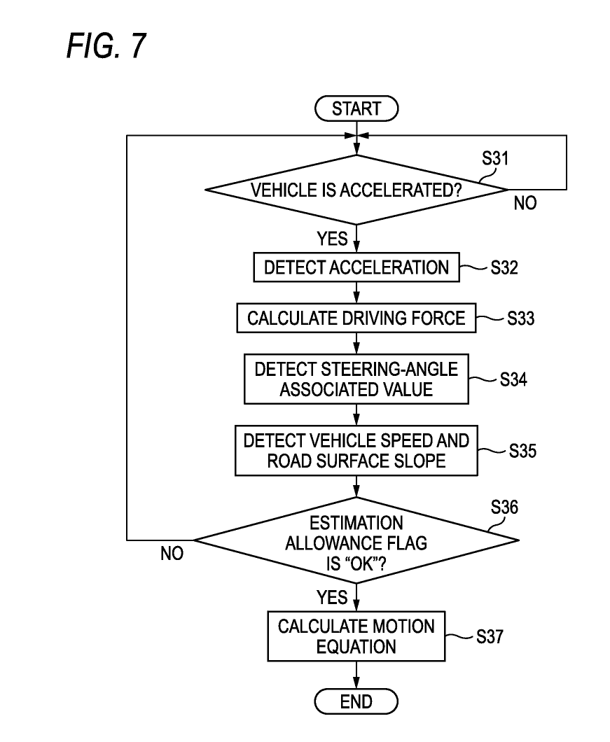

FIG. 7 is a flow chart illustrating an exemplary procedure of estimating vehicle mass M. In Step S31, the calculating unit 3 determines whether the vehicle 100 is being accelerated. When the vehicle 100 is being accelerated, the calculating unit 3 detects acceleration α10 in Step S32, and calculates a driving force Fp10 in Step S33. Then, the calculating unit 3 detects a steering-angle associated value STR10 in Step S34, and detects a vehicle speed V10 and a road surface slope δ10 in Step S35. Next, in Step S36, the calculating unit 3 determines whether the vehicle mass M can be estimated. If the estimation allowance flag is “OK (allow)”, the procedure proceeds to Step S37 where the calculating unit 3 calculates a motion equation, thereby estimating the vehicle mass M. If the estimation allowance flag is “NG (disallow)”, or if it is determined in Step S31 that the vehicle 100 is not being accelerated, the calculating unit 3 returns to Step S31.

The acceleration detecting unit 31 detects the acceleration α10 of the vehicle 100 during acceleration. The driving-force calculating unit 32 calculates the driving force Fp10 of the vehicle 100 corresponding to the acceleration α10. The steering-angle associated value detecting unit 33 detects a steering angle θ10 and steering speed Vθ10 of the vehicle 100 at the detection time of the acceleration α10. The steering angle θ10 and the steering speed Vθ10 are the steering-angle associated value STR10. The steering-angle associated value detecting unit 33 can detect at least one of the steering angle θ10 and the steering speed Vθ10 as the steering-angle associated value STR10. Further, methods of detecting the acceleration α10, the steering angle θ10, and the steering speed Vθ10, and a method of calculating the driving force Fp10 are the same as those in the first illustrative embodiment.

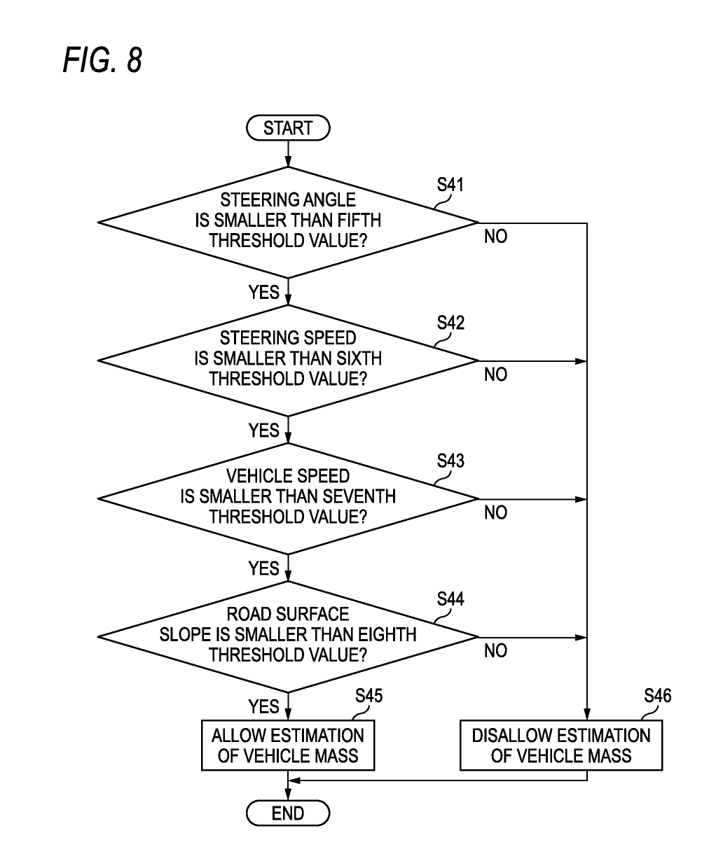

The mass estimating unit 34 detects the vehicle speed V10 of the vehicle 100 and the road surface slope δ10 at the detection time of the acceleration α10. Methods of detecting the vehicle speed V10 and the road surface slope δ10 are the same as those in the first illustrative embodiment. FIG. 8 is a flow chart illustrating an exemplary procedure of determining whether the vehicle mass M can be estimated. In FIG. 8, as the steering-angle associated value STR10, the steering angle θ10 and the steering speed Vθ10 are used. In Step S41, the mass estimating unit 34 determines whether the steering angle θ10 is smaller than a fifth threshold value TH5. When the steering angle θ10 is smaller than the fifth threshold value TH5, the procedure proceeds to Step S42. In Step S42, the mass estimating unit 34 determines whether the steering speed Vθ10 is smaller than a sixth threshold value TH6. When the steering speed Vθ10 is smaller than the sixth threshold value TH6, the mass estimating unit 34 proceeds to Step S43.

In Step S43, the mass estimating unit 34 determines whether the vehicle speed V10 is smaller than a seventh threshold value TH7. When the vehicle speed V10 is smaller than the seventh threshold value TH7, the procedure proceeds to Step S44. In Step S44, the mass estimating unit 34 determines whether the road surface slope δ10 is smaller than an eighth threshold value TH8. When the road surface slope 610 is smaller than the eighth threshold value TH8, the procedure proceeds to Step S45 where the mass estimating unit 34 sets the estimation allowance flag of the vehicle mass M to “OK (allow)”. Then, the mass estimating unit 34 uses a relational expression represented by the following equation 4, to estimate the vehicle mass M. When at least one of the conditions of Steps S41 to S44 is not satisfied, the procedure proceeds to Step S46 where the mass estimating unit 34 sets the estimation allowance flag of the vehicle mass M to “NG (disallow)”. In this case, the mass estimating unit 34 does not estimate the vehicle mass M. Also, the fifth to eighth threshold values TH5 to TH8 are acceptable values at which it is possible to ignore the running resistance Fr, and can be derived in advance by simulations, measurement using actual equipment, or the like, and be stored in the memory 12.

Now, a method of estimating the vehicle mass M will be described. The mass estimating unit 34 estimates the vehicle mass M using the relational expression represented by the following equation 4. In this case, the rolling resistance Ft at the detection time of the acceleration α10 is represented by Ft10, and the wind resistance Fw is represented by Fw10. Also, the resistance Fx occurring in the backward movement direction of the vehicle at the detection time of the acceleration α10 is represented by Fx10, and the cornering drag Fc is represented by Fc10. The rolling resistance Ft10, the wind resistance Fw10, the resistance Fx10, and the cornering drag Fc10 have characteristics obtained in advance by simulations, measurement using actual equipment, or the like, and can be stored by a map, a table, a relational expression, or the like, in the memory 12.

M={Fp10−(Ft10+Fw10+Fx10+Fc10)}/α10 (Equation 4)

In the present illustrative embodiment, since the mass estimating unit 34 estimates the vehicle mass M when the steering-angle associated value STR10 is smaller than the threshold value, it is possible to estimate the vehicle mass M when the cornering drag Fc included in the running resistance Fr occurring at the vehicle 100 is small. Therefore, it is possible to suppress an estimation error of the vehicle mass M based on the cornering drag Fc, thereby improving the accuracy of estimation of the vehicle mass M.

### (3) Others

The present invention is not limited to the above-described illustrative embodiments and shown in the drawings, but can be appropriately modified within the scope of the invention. For example, the mass estimating unit 34 can estimate the vehicle mass M at timings when the transmission is shifted from the first gear to the second gear, from the second gear to the third gear, from the third gear to the fourth gear, or the like. Also, the mass estimating unit 34 can also estimate the vehicle mass M at the plurality of timings, and can use them together to reduce an estimation error of the vehicle mass M.

Also, the mass estimating unit 34 can estimate the vehicle mass M when the vehicle 100 is coasting or being decelerated. Specifically, for example, in timings when the transmission is shifted from the fourth gear to the third gear, from the third gear to the second gear, from the second gear to the first gear, or the like, the mass estimating unit 34 can estimate the vehicle mass M. Also, the mass estimating unit 34 can estimate the vehicle mass M at the plurality of timings, and can use them together to reduce an estimation error of the vehicle mass M. Further, it is possible to detect the acceleration α of the vehicle 100 two times in one of running conditions where the vehicle 100 is being accelerated, being decelerated, or coasting, in order to estimate the vehicle mass M. Also, in the above-mentioned illustrative embodiments, the acceleration α, the driving force Fp, and the steering-angle associated value STR are detected in the same cycle. However, they may be detected in different cycles. In other words, as long as it is possible to suppress the estimation error of the vehicle mass M within an acceptable range, it is possible to shift the detection timings of the acceleration α, the driving force Fp, and the steering-angle associated value STR with respect to one another.

What is claimed is:

1. A vehicle mass estimating apparatus comprising:
an acceleration detecting unit which detects an acceleration of a vehicle;
a driving-force calculating unit which calculates a driving force of the vehicle corresponding to the acceleration;
a steering-angle associated value detecting unit which detects a steering-angle associated value which is associated with a steering angle of the vehicle at a detection time of the acceleration; and
a mass estimating unit which estimates a vehicle mass at the detection time of the acceleration based on the acceleration and the driving force on a condition that the steering angle associated value satisfies a predetermined condition.

2. The vehicle mass estimating apparatus according to claim 1,
wherein the acceleration detecting unit detects the acceleration at two or more timings, and
wherein the mass estimating unit applies accelerations detected at the two or more timings and driving forces corresponding to the accelerations, to two or more relational expressions, each representing a relation among the acceleration, the driving force, a running resistance of the vehicle, and the vehicle mass at a corresponding timing, and estimates the vehicle mass based on the relational expressions on a condition that a change amount between the steering-angle associated values detected at the two or more timings is smaller than a predetermined threshold value.

3. The vehicle mass estimating apparatus according to claim 1,
wherein the steering-angle associated value detecting unit detects the steering angle of the vehicle as the steering-angle associated value.

4. The vehicle mass estimating apparatus according to claim 1,
wherein the steering-angle associated value detecting unit detects a steering speed of the vehicle as the steering-angle associated value.
